(19) United States
(12) Patent Application Publication
(10) Pub. No.: US 2009/0314220 A1
(43) Pub. Date: Dec. 24, 2009

(54) Modular Fence Panel and Connecting Member for Welded Wire Kennel

(76) Inventors: William S. Groh, Knoxville, TN (US); Darren S. Light, Powell, TN (US); Christopher E. Mainini, Knoxville, TN (US); Kevin M. Sayers, Kodak, TN (US); John G. Spangler, Knoxville, TN (US)

Correspondence Address: PITTS AND BRITTIAN P C, P O BOX 51295, KNOXVILLE, TN, 37950-1295, US

(21) Appl. No.: 12/430,571

(22) Filed: Apr. 27, 2009

Related U.S. Application Data
(62) Division of application No. 12/141,951, filed on Jun. 19, 2008, now abandoned.

(51) Int. Cl. A01K 1/02

(52) U.S. Cl. 119/502

(57) ABSTRACT

A modular fence panel system for constructing at least a portion of a pet kennel. The modular fence panel system of the present invention includes at least first and second modular fence panel members, which include a panel member having first and second vertical sides and upper and lower horizontal sides. Upper and lower frame members are secured to the upper and lower horizontal sides of the panel member. At least one vertical side of the panel member is left exposed. A joining member having an elongated tube member and upper and lower cross members is used to secure the first and second modular fence panel members to each other.

### CROSS-REFERENCE TO RELATED APPLICATIONS

This is a divisional of U.S. patent application Ser. No. 12/141,951, filed Jun. 19, 2008.

### STATEMENT REGARDING FEDERALLY-SPONSORED RESEARCH OR DEVELOPMENT

Not Applicable

### BACKGROUND OF THE INVENTION

1. Field of Invention

The invention relates to the field of wire pet kennels. More specifically, it relates to a novel, low-cost modular fence panel and cooperating joiner rail that can be quickly adjoined with a similarly constructed modular fence panel for constructing at least a portion of a wire box kennel.

2. Description of the Related Art

Pet kennels are conventionally constructed of square or rectangular sections of fencing, four of which typically form the front, back, and two sides of the kennel. A wire mesh, such as is used in chain-link fencing, provides the fencing fabric. For instance, U.S. Pat. No. 4,422,622 issued to Stanley M. Broski, Jr. on Dec. 27, 1983, discloses a prefabricated fence panel construction for dog kennels and the like. Broski's fence panel utilizes top, bottom and side rails that telescopically interfit to form a perimeter. A selectively dimensioned section of chain-link fencing fabric is secured to the side rails in a manner that subjects the telescopically interfitted rail members to forces which tend to pull the same together, such that the completed panel is structurally self-sustaining and “rigidified”.

What is missing in the art is a modular fence panel and cooperating joiner rail that can be quickly and easily connected to a series of adjoining, similarly constructed modular fence panels in order to erect kennels of various dimensions.

### BRIEF SUMMARY OF THE INVENTION

A modular fence panel system for constructing pet kennels of selected sizes is disclosed. It will be appreciated by those skilled in the art that a conventional pet kennel is frequently longer than it is wide. This necessitates having very long packaging to accommodate the long side of pet kennels that are sold to the consumer for consumer assembly. Or, in where the pet kennel is sold to the consumer pre-assembled, it requires truck delivery. The modular fence panel of the present invention makes it possible to connect a plurality of smaller than conventional fencing panels in order to form a larger fence panel without using conventional/traditional kennel/fence clamping methods. Thus, kennels can be sold to pet owners in a smaller package that is more easily transportable by the consumer than conventional kennels.

The modular fence panel of the present invention includes a panel member, preferably constructed of welded wire mesh. The panel member is welded to three frame members, an upper frame member, a lower frame member, and a side, or vertical frame member. The fourth side of the panel member, i.e. the side oppositely disposed from the vertical frame member is exposed, i.e. it is not welded to a frame member. A joining member is constructed of metal tubing, either square, round, or rectangular, that is constructed such that it has two grooves oppositely disposed from one another.

Upper and lower cross members are attached on the upper and lower ends of the joining member respectively. The joining member is then placed between two modular fence panels and joined by attaching the top and bottom members of the joining member to the upper and lower frame members respectively. The exposed wire edges of the panel members are received by the grooves of the joining member. In this manner, the joining member securely covers the cut edges of the panel member providing certain aesthetic benefits, in that it covers any surface rust that may form at the cut ends of the panel member and inasmuch as it provides for proper alignment of the wire members of the panel member. The joining member also serves to enhance the rigidity of the panel member.

With regard to the grooves disposed in the joining member, the grooves are oppositely disposed on joining members that are utilized for increasing the total length of the side of a kennel. Where corners are desired to be joined, i.e. where two cooperating modular fence panels are to be joined at a corner, it will be appreciated by those skilled in the art that the grooves will be orthogonally disposed. Further, it will be appreciated that the grooves can be oriented one to another at various angles, 180°, 90°, 60°, 45°, 30°, or other selected angles in order to make kennels of various configurations.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an elevation view of the modular fence panel for constructing pet kennels of the present invention.

FIG. 2 is a cross sectional view, taken at sectional line A-A of FIG. 1.

FIG. 3 is a perspective view, in section, of the joining member of the present invention.

FIG. 4 is an elevation view of the distal end of the joining member of the present invention.

FIG. 5 is an exploded view of a kennel side constructed with two cooperating modular fence members, and a joining member.

FIG. 6 shows detail B of FIG. 5 on a larger scale.

FIG. 7 is an elevation view of the constructed kennel side illustrated in FIG. 5.

FIG. 8 shows detail C of FIG. 7 on a larger scale.

FIG. 9 is a perspective view, in section, of an alternate embodiment joining member.

FIG. 10 is a perspective view, in section, of another alternate embodiment joining member.

FIG. 11 is a perspective view, in section, of a joining member for forming a corner from two cooperating modular fence panels constructed in accordance with the present invention.

FIG. 12 is a detail perspective view of an alternate embodiment modular fence panel.

FIG. 13 is an alternate embodiment of the modular fence panel of FIG. 1.

FIG. 14 is an exploded view of an alternate embodiment of the joining member of FIG. 5.

FIG. 15 is a perspective view of the joining member of FIG. 14.

FIG. 16 illustrates the joining member of FIG. 14 adjoining two modular fence panels of FIG. 13.

FIG. 17 illustrates an alternate embodiment of the joining member of FIG. 14 that extends diagonally between two adjoined modular fence panels.

### DETAILED DESCRIPTION OF THE INVENTION

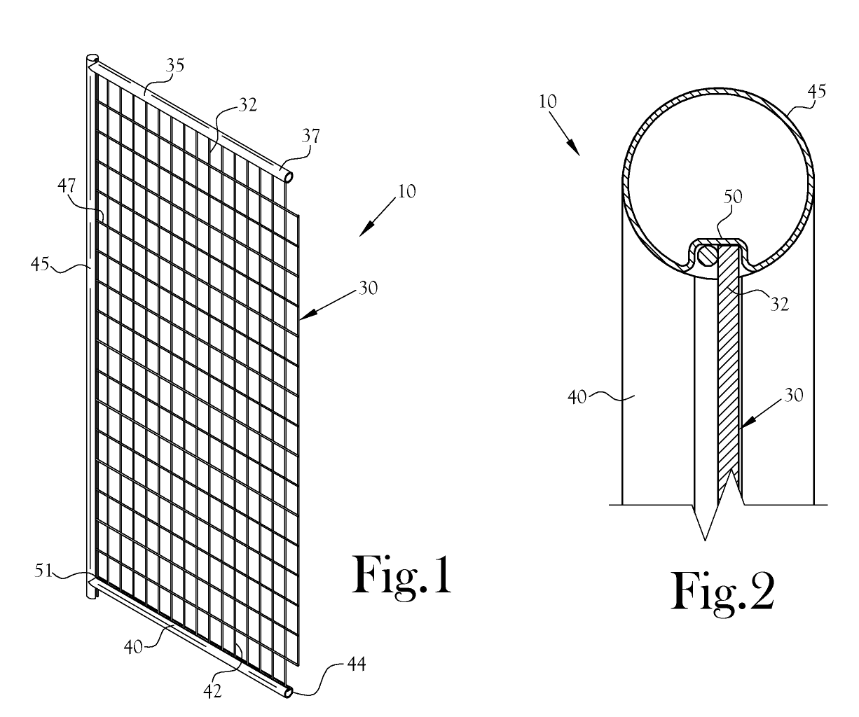

A modular fence panel system constructed in accordance with the present invention is identified generally as 10 in the figures. In order to assemble a pet kennel utilizing modular fence panel 10, one or more modular fence panels are adjoined with joining member 20. Modular fence panel 10 includes a panel member 30, preferably constructed of welded wire mesh. In one embodiment, the panel member 30 has three sides, an upper side 32, a lower side 42, and a vertical side 47 welded to three frame members, an upper frame member 35, a lower frame member 40, and a side, or vertical frame member 45, respectively. In this regard, as illustrated at FIG. 2, each frame member has a linear groove 50 that receives the respective sides of panel member 30. In one embodiment, the linear groove 50 of the lower frame member 40 and the linear groove 50 of the vertical frame member 45 provide the modular fence panel system with a drainage feature. More specifically, as illustrated at FIG. 1, where the lower frame member 40 abuts the vertical frame member 45, the linear groove 50 of the vertical frame member 45 defines an opening 51 between the vertical frame member 45 and the lower frame member 40. When rain and other moisture collect at and trickle down the modular fence panel 10, the moisture makes its way to and is collected within the linear groove 50 of the lower frame member 40. Under the force of gravity, the moisture collected within the linear groove 50 of the lower frame member 40 is channeled to and through the opening 51 defined by the vertical frame member 45 and the lower frame member 40. Moisture passing through the opening 51 is directed toward a solitary location at the ground such that the moisture does not gather about the lower frame member 40. In the illustrated embodiment, the linear groove 50 has a square contour. However, it should be noted that the linear groove 50 can have a triangular, hexagonal, or other contour without departing from the scope or spirit of the present invention.

The panel member 30 is preferably planar. Moreover, while the illustrated panel member 30 is constructed of welded wire mesh, it will be appreciated that the panel member could be constructed of other fencing materials such as plastic, expanded metal or metal lattice. In the illustrated embodiment, the fourth side 90 of the panel member, i.e. the side oppositely disposed from vertical side 47 and vertical frame member 45 is exposed, i.e. it is not welded to a frame member. Further, the upper frame member 35 and the lower frame member 40 each have a distal end 37 and 44 respectively, oppositely disposed from the vertical frame member 45.

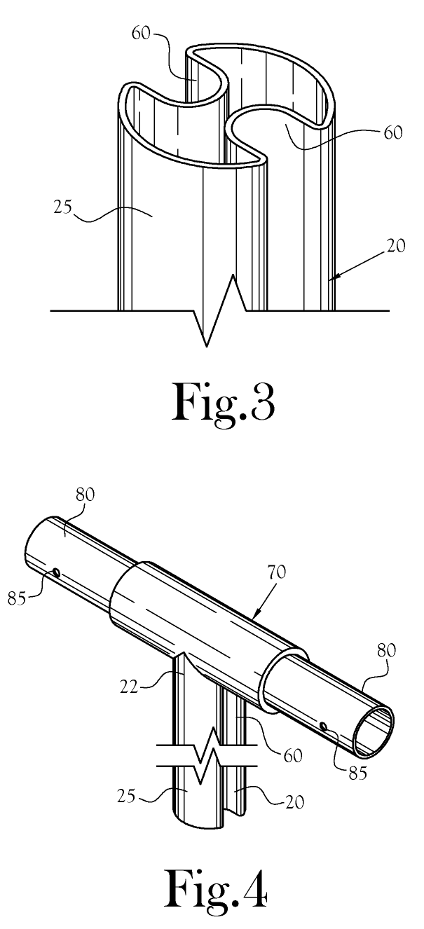

In the illustrated embodiments detailed in FIGS. 3 and 4, joining member 20 is constructed of elongated round metal tube member 25. An upper cross member 70 and a lower cross member 75 are attached on the upper end 22 and the lower end 24 of the elongated metal tube 25 of the joining member 20 respectively. Upper and lower cross members 70 and 72 are disposed substantially perpendicularly to the elongated metal tube member 25. Further, the elongated metal tube member 25 of the joining member 20 is provided with at least two linear grooves 60 the function of which will be described in greater detail herein below. Upper and lower cross members 70 and 72 include distal ends 80 which are dimensioned to be telescopically engage the distal ends 37 and 44 of the upper frame member 35 and lower frame member 40, respectively. Further, distal ends 80 include fastener hole members 85 which cooperate with similar hole members disposed on the distal ends 37 and 44 of the upper frame member 35 and lower frame member 40, respectively, for receiving a fastener 88 for securing joining member 20 to modular fence panel 10. While a specific fastener 88 has been discussed and illustrated, it should be noted that a fastener 88 other than the discussed and illustrated fastener 88 can be used without departing from the scope or spirit of the present invention.

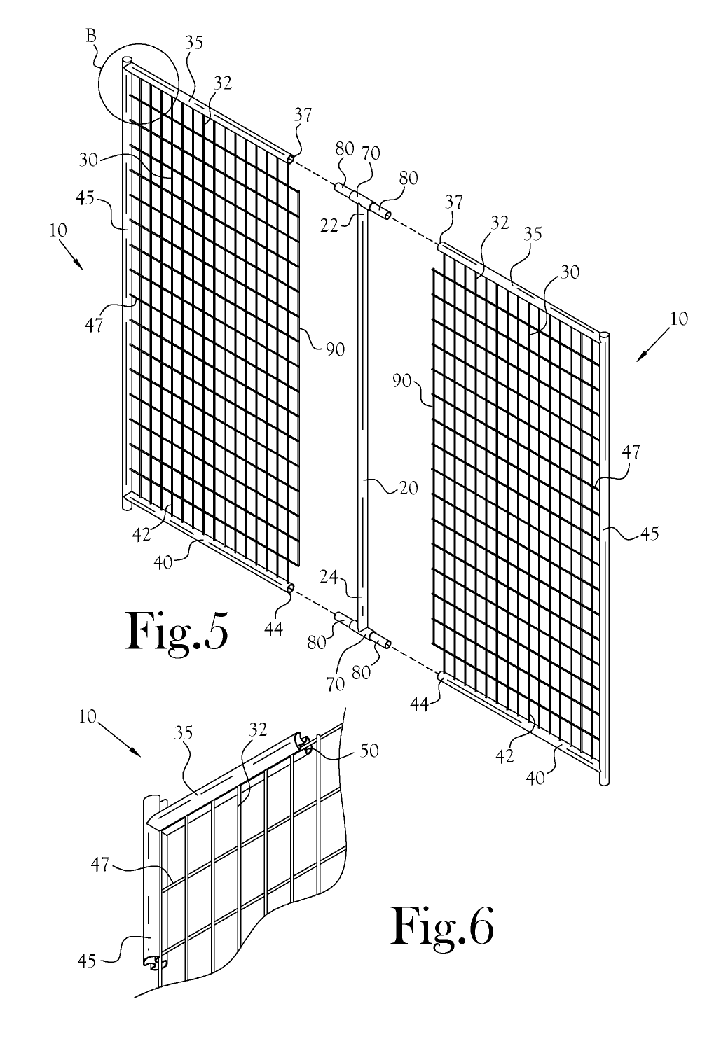

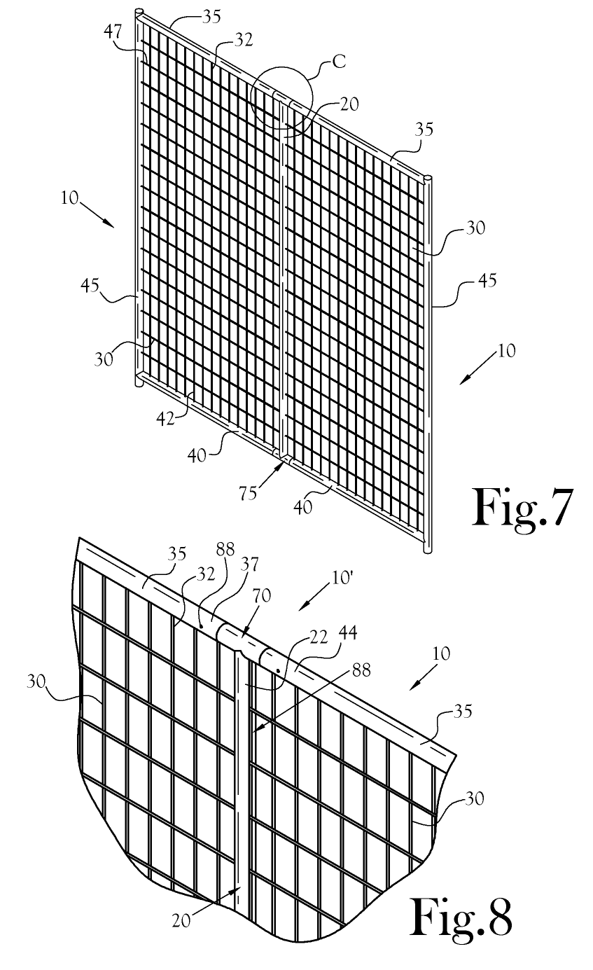

Referring to FIG. 5, operation of the modular fence panel 10 for constructing a pet kennel side will be illustrated. Two modular fence panels 10 are placed into close proximity, such that sides 90 of each of the modular fence panels 10 are proximate each other. Joining member 20 is interposed between the two modular fence panels 10 such that the distal ends 80 of upper cross member 70 register with the distal ends 37 of the upper frame member 35 and the distal ends 80 of the lower cross member 75 register with the distal ends 44 of the lower frame member 40. As the distal ends 80 of upper cross member 70 and the distal ends 80 of the lower cross member 75 are brought into a telescoping engagement with the distal ends 37 of the upper frame member 35 and the distal ends 44 of the lower frame member 40, respectively, the fourth side 90 of the modular fence panel 10 is received by grooves 60 in the joining member 20. In this manner, the joining member 20 securely covers the cut edges comprising the fourth side 90 of the panel member 30, providing certain aesthetic benefits, in that it covers any surface rust that may form at the cut ends of the fourth side 90 of the panel member 30. The joining member 20 in this manner also serves to enhance the rigidity of the modular panel member 10.

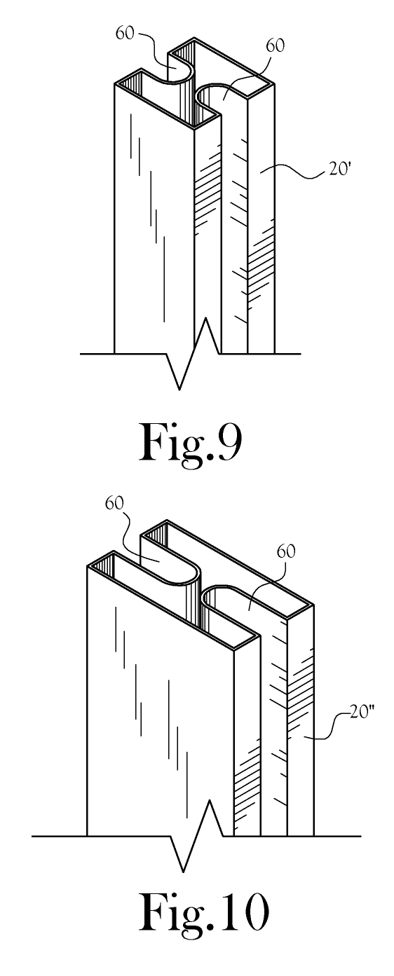

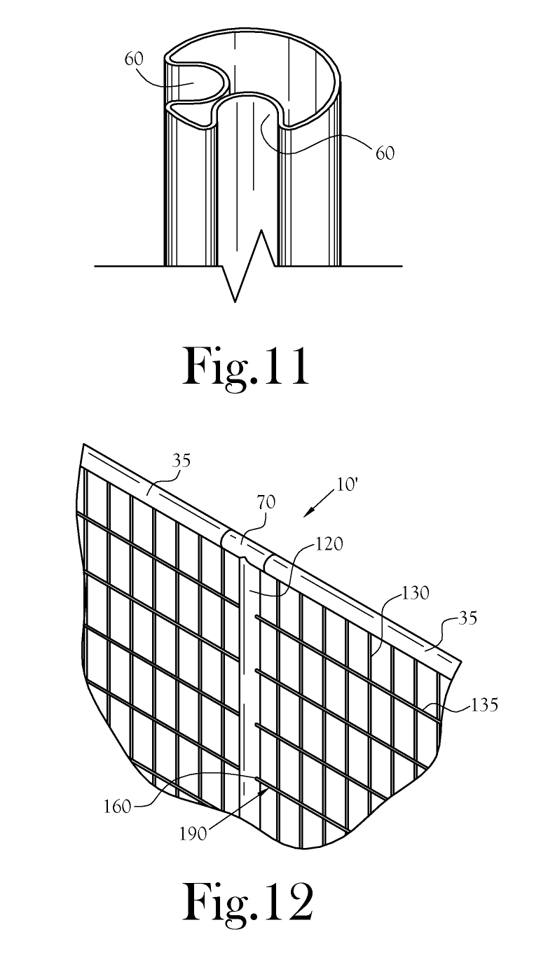

While joining member 20, as illustrated in FIGS. 3 and 4 is constructed of elongated round metal tubing, it will be appreciated that an alternate embodiment joining member 20′, illustrated in FIG. 9, could be constructed of square metal tubing. A further alternate embodiment joining member 20″, illustrated in FIG. 10, could be constructed of rectangular metal tubing. And, whereas joining member 20 is illustrated and described as metal tubing, it will be appreciated that it could be of solid construction and could be extruded. It will also be appreciated that other substantially rigid materials, such as plastics or composites, could be utilized.

With regard to the grooves 60 disposed in the joining member 20, the grooves 60 are oppositely disposed, i.e. 180° opposed, on joining members 20 that are utilized for increasing the total length of the side of a kennel. Where corners are desired to be joined, i.e. where two cooperating modular fence panels 10 are to be joined at a corner, it will be appreciated by those skilled in the art that the grooves 60 will be orthogonally disposed, i.e. disposed approximately 90° from one another. Further, it will be appreciated that the grooves 60 can be oriented one to another at various other angles, 60°, 45°, 30°, or other selected angles in order to make corners of various configurations.

Referring to FIG. 12, an alternate embodiment joining member 120 is illustrated. In this regard, with the embodiment of the modular fence panel 10′ that utilizes joining member 120, the vertical side 190 of the panel member 130 is cut such that only the ends of the horizontal wires 135 are exposed. Joining member 120 is fashioned with rows of hole members 160, rather than grooves, which register with, and receive, the ends of the horizontal wires 135. In this manner the ends of the horizontal wires 135 are secured and concealed by joining member 120.

It will also be appreciated that in situations where more than two modular fence panels 10 are to be joined in succession, an alternate embodiment modular fence panel 110 would be utilized. In this regard, modular fence panel 110 is similar in all respects to the modular fence panel 10 described herein above, with the exception that it does not include vertical frame member 45. Rather, vertical side 147 of the panel member 130 is oppositely disposed from the vertical side 90 of the panel member 30. In this manner, modular fence panel 110 would be interposed between two modular fence panels 10 with two joining members 20 securing modular fence panels 10 to modular fence panel 110.

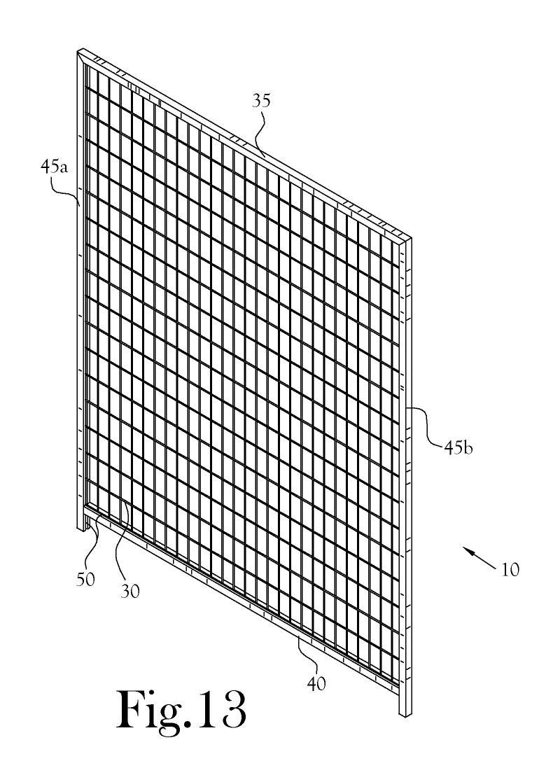

FIG. 13 illustrates an alternate embodiment of the modular fence panel 10 in accordance with the various features of the present invention. In the illustrated embodiment, the modular fence panel 10 includes the panel member 30 welded to the upper frame member 35, the lower frame member 40, a first vertical frame member 45a, and a second frame member 45b. Stated differently, a frame member is welded to each side of the panel member 30 such that the frame members circumscribe the panel member 30. Additionally, in the illustrated embodiment, the frame members have a square contour. However, it should be noted that the frame members can have a contour other than the illustrated square and circular contours without departing from the scope or spirit of the present invention.

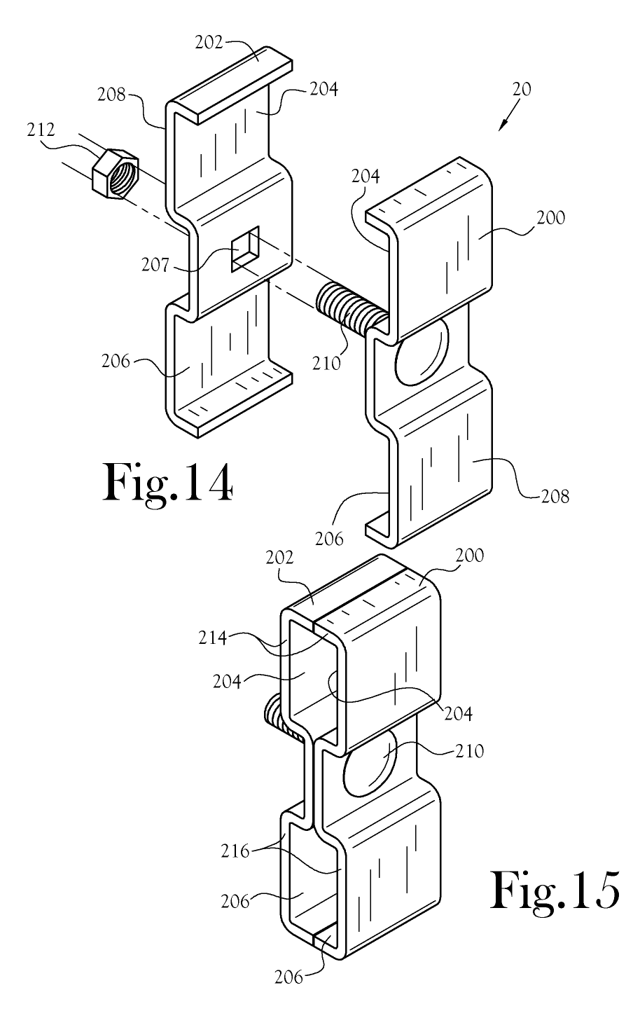

FIG. 14 illustrates an alternate embodiment of the joining member 20 in accordance with the various features of the present invention. The alternate embodiment of the joining member 20 adjoins the modular fence panels 10 illustrated at FIG. 13. More specifically, the joining member 20 includes a first bracket member 200 and a second bracket member 202. Each of the first bracket member 200 and the second bracket member 202 include a first interior surface 204, a second interior surface 206, and an exterior surface 208, which is opposite the interior surfaces 204 and 206. Additionally, the first bracket member 200 and the second bracket member 202 define a first opening 205 and a second opening 207, respectively. The joining member 20 includes a bolt 210 that is received by the first opening 205 of the first bracket member 200 such that the bolt 210 extends from the first bracket member 200 in the direction of the interior surfaces 204 and 206. The bolt 210 is disposed within the first opening 205 and secured to the first bracket member 200 such that the bolt 210 does not rotate within the first opening 205. In one embodiment, the bolt 210 is tack welded to the first bracket member 200. The bolt 210 is also received by the second opening 207 of the second bracket member 202 such that the interior surfaces 204 and 206 of the first bracket member 200 oppose the interior surfaces 204 and 206 of the second bracket member 202. The joining member 20 includes a nut 212 that is removably secured to the bolt 210 at the exterior surface 208 of the second bracket member 202 such that the first bracket member 200 is removably secured to the second bracket member 202. In one embodiment, the bolt 210 and nut 212 include respective and cooperating threaded portions such that the nut 212 is removably secured to the bolt 210. Because the bolt 210 is secured to the first bracket member 200 such that the bolt 210 does not rotate within the first opening 205, the joining member 20 provides an ease of assembly feature. More specifically, one does not have to manually prevent the bolt 210 from rotating within the first opening 205 when securing the nut 212 to the bolt 210 such that the first bracket member 200 can be secured to the second bracket member 202 using only one hand.

As illustrated at FIG. 15, when the first bracket member 200 is secured to the second bracket member 202, the first interior surfaces 204 of the first bracket member 200 and the second bracket member 202 define a first collar 214, which receives the vertical frame members 45 of the modular fence panel 10. Similarly, when the first bracket member 200 is secured to the second bracket member 202, the second interior surfaces 206 of the first bracket member 200 and the second bracket member 202 define a second collar 216, which receives the vertical frame members 45 of the modular fence panel 10.

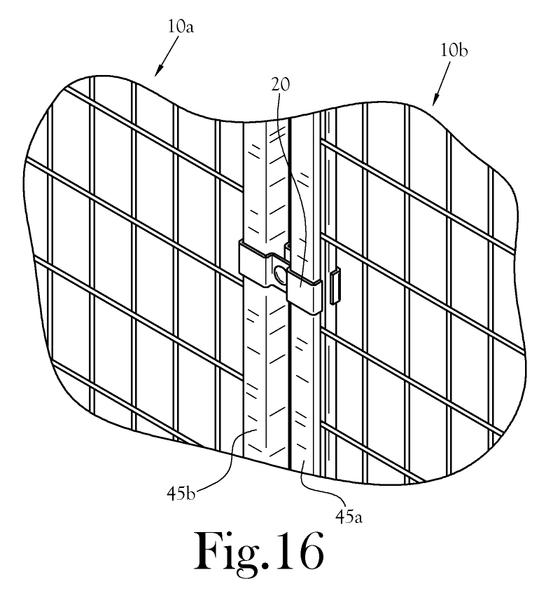

FIG. 16 illustrates the joining member 20 of FIGS. 14 and 15 adjoining a first modular fence panel 10a of FIG. 13 and a second modular fence panel 10b of FIG. 13. The first collar 214 of the joining member 20 receives the second vertical frame member 45b of first modular fence panel 10a. Additionally, the second collar 216 of the joining member 20 receives the first vertical frame member 45a of the second modular fence panel 10b. When the collars 214 and 216 of the joining member 20 receive the respective vertical frame members 45, the first modular fence panel 10a is secured to the second modular fence panel 10b. Although the first collar 214 and the second collar 216 of the illustrated embodiment have a square contour to cooperate with the square contour of the vertical frame members 45 of the illustrated embodiment, it should be noted that the first collar 214 and the second collar 216 of the joining member 20 can have a contour other than a square contour, such as a circular contour, without departing from the scope or spirit of the present invention.

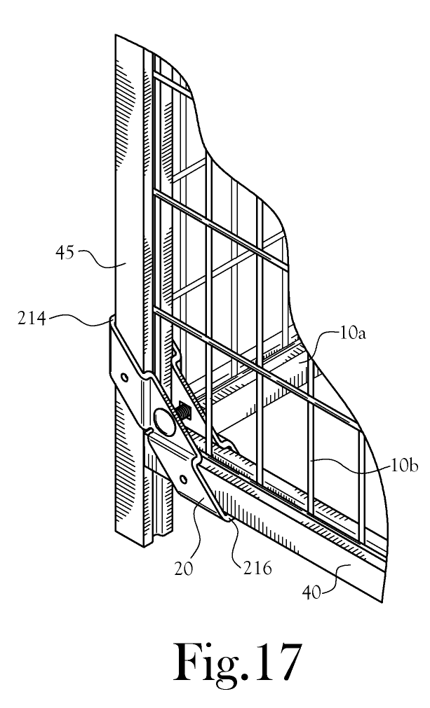

FIG. 17 illustrates an alternate embodiment of the joining member 20 of FIGS. 14 and 15. In the alternate embodiment, the first collar 214 is adapted to receive a vertical frame member 45 of the first modular fence panel 10ₐ and the second collar 216 is adapted to receive a lower frame member 40 of the second modular fence panel 10_{b} such that the joining member 20 extends diagonally between the received members. The joining member 20 provides structural support during the assembly of the modular fence panels 10 and further secures the first modular fence panel 10ₐ to the second modular fence panel 10_{b}.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A modular fence panel system for assembling at least a portion of a pet kennel, said modular fence panel system comprising:
at least first and second modular fence panel members, each of said modular fence panel members including a panel member having first and second vertical sides and an upper horizontal side and a lower horizontal side, said modular fence panel members further including an upper frame member secured to said upper horizontal side and a lower frame member secured to said lower horizontal side, said upper frame member and said lower frame member each having distal ends, wherein said upper frame member includes a longitudinal groove for receiving at least a portion of said upper horizontal side and said lower frame member includes a longitudinal groove for receiving at least a portion of said lower horizontal side; and
a joining member having an elongated tube member having an upper end and a lower end and at least one longitudinal groove disposed therein, said joining member further having an upper cross member carried by said upper end of said elongated tube member and a lower cross member carried by said lower end of said elongated tube member, wherein said upper and lower cross members each have distal ends selectively dimensioned to be telescopically engaged by said distal ends of said upper and lower frame members;
whereby said joining member is disposed between said first and said second modular fence panel members such that said distal ends of said upper and said lower frame members telescopically engage with said distal ends of said upper and said lower cross members and at least a portion of said vertical side of said panel member is received by said longitudinal groove of said joining member.

2. The modular fence panel system for assembling at least a portion of a pet kennel of claim 1, wherein each of said cross members is disposed substantially perpendicular to said elongated tube member.

3. The modular fence panel system for assembling at least a portion of a pet kennel of claim 1, wherein said panel member is constructed of welded wire mesh.

4. The modular fence panel system for assembling at least a portion of a pet kennel of claim 1, wherein said panel member is constructed of expanded metal.

5. The modular fence panel system for assembling at least a portion of a pet kennel of claim 1, wherein said panel member is constructed of metal lattice.

6. The modular fence panel system for assembling at least a portion of a pet kennel of claim 1, wherein said panel member is constructed of plastic.

7. The modular fence panel system for assembling at least a portion of a pet kennel of claim 1, wherein said modular fence panel member further includes a vertical frame member secured to a vertical side of said panel member, said vertical frame member having a longitudinal groove for receiving at least a portion of said vertical side of said panel member.

8. The modular fence panel system for assembling at least a portion of a pet kennel of claim 1, wherein said panel member is substantially planar.

9. The modular fence panel system for assembling at least a portion of a pet kennel of claim 1, wherein said distal ends of said cross members include fastener hole members and further wherein said distal ends of said upper frame member and said lower frame member include fastener hole members which register with said fastener hole members on said cross members for receiving a fastener for securing said joining member to said modular fence panel.

10. The modular fence panel system for assembling at least a portion of a pet kennel of claim 1, wherein said joining member includes first and second grooves that are oppositely disposed from one another.

11. The modular fence panel system for assembling at least a portion of a pet kennel of claim 10 wherein said first and said second grooves are disposed 180° from one another.

12. The modular fence panel system for assembling at least a portion of a pet kennel of claim 10 wherein said first and said second grooves are substantially orthogonally disposed from one another.
